(19) United States
(12) Patent Application Publication
(10) Pub. No.: US 2011/0075300 A1
(43) Pub. Date: Mar. 31, 2011

(54) Reducing the Propagation of Vibrations to an HDD Head

(76) Inventors: Norbert A Feliss, Aptos, CA (US); Karl Arthur Flechsig, Los Gatos, CA (US); Donald Ray Gillis, San Jose, CA (US)

(21) Appl. No.: 12/570,272

(22) Filed: Sep. 30, 2009

(51) Int. Cl. G11B 21/16

(52) U.S. Cl. 360/244; G9B/21.023

(57) ABSTRACT

Approaches for reducing vibrations, such as resonance vibrations, that are propagated to a hard-disk drive (HDD) head are disclosed. A hard-disk drive may compromise a lead suspension that includes a magnetic read/write head. The magnetic read/write head may be connected to the lead suspension by a plurality of leads. A portion of each of the plurality of leads, such as the solder ball joints, may be covered by a dampening material that is designed to absorb vibrations occurring in the lead suspension to prevent transmission of the vibrations to the magnetic read/write head. Alternately, the dampening material may be applied to other locations, such as the limiter engagements, which can transmit vibrations to the magnetic read/write head.

### FIELD OF THE INVENTION

Embodiments of the invention generally relate to reducing the propagation of vibrations to a hard-disk drive (HDD) head.

### BACKGROUND OF THE INVENTION

A hard-disk drive (HDD) is a non-volatile storage device that is housed in a protective enclosure and stores digitally encoded data on one or more circular disks having magnetic surfaces (a disk may also be referred to as a platter). When an HDD is in operation, each magnetic-recording disk is rapidly rotated by a spindle system. Data is read from and written to a magnetic-recording disk using a read/write head which is positioned over a specific location of a disk by an actuator.

A read/write head uses a magnetic field to read data from and write data to the surface of a magnetic-recording disk. As a magnetic dipole field decreases rapidly with distance from a magnetic pole, the distance between a read/write head and the surface of a magnetic-recording disk must be tightly controlled. To provide a uniform distance between a read/write head and the surface of a magnetic-recording disk, an actuator relies on air pressure inside the hard drive enclosure to support the read/write heads at the proper distance away from the surface of the magnetic-recording disk while the magnetic-recording disk rotates. A read/write head therefore is said to “fly” over the surface of the magnetic-recording disk. That is, the air pulled along by a spinning magnetic-recording disk forces the head away from the surface of the magnetic-recording disk. When the magnetic-recording disk stops spinning, a read/write head must either “land” or be pulled away.

A write-head of a HDD records data onto the surface of a magnetic-recording disk in a series of concentric tracks. When a write-head writes data to a desired track of a magnetic-recording disk, it is important for the write-head to be located close to the desired track; failure to do so may result in a squeeze event, which may compromise data integrity and throughput, and in extreme cases, may result in hard errors and data loss. A squeeze event occurs when a write-head writes data too close to or overlapping with an adjacent track such that there is not enough of the adjacent track left for the adjacent track to be read properly by a read-head.

References markers may be recorded in each track of a magnetic-recording disk. These reference markers are referred to as servo information. To help properly position a read/write head, a HDD employs a servo mechanical control loop to maintain the read/write head in the correct position using the servo information stored on the magnetic-recording disk. When a read/write head reads the servo information (servo information being read may be referred to as a position-error signal, or PES), a relative position of the read/write head may be determined by a servo processor to enable the position of the read/write head, relative to the desired track, to be adjusted if necessary.

It is desirable, for a variety of reasons, to maintain a constant or approximately constant distance between the read/write head and the surface of the magnetic-recording disk to ensure proper operation of the read/write head. If the distance between a read/write head and the surface of a magnetic-recording disk fluctuates, then the strength of the magnetic dipole field between the read/write head and the surface of the magnetic-recording disk will also fluctuate, which may cause problems in reading data from or writing data to the magnetic-recording disk. Also, if the read/write head touches the surface of the magnetic-recording medium, then read/write head may scrape across the surface of a platter, which could grind away the thin magnetic film on the surface magnetic-recording medium and therefore cause data loss and potentially render the HDD inoperable.

### SUMMARY OF THE INVENTION

It is observed that vibrations experienced by a lead suspension of a hard-disk drive (HDD) may be propagated to a head. The lead suspension may start to vibrate for different reasons, such as the HDD experiencing a mechanical shock, the circulating air flow within the HDD, and resonance vibrations.

Approaches are discussed herein for reducing the propagation of vibrations to a head of a persistent storage medium, such as a HDD. An HDD may compromise a lead suspension that includes a magnetic read/write head. The magnetic read/write head may be connected to the lead suspension by a plurality of leads. A portion of each of the plurality of leads, such as the solder ball joints, may be covered by a dampening material that is designed to absorb vibrations occurring in the lead suspension to prevent transmission of the vibrations to the magnetic read/write head. Alternately, the dampening material may be applied to other locations which can transmit vibrations to the magnetic read/write head, such as the limiter engagements. In this way, the dampening material reduces or eliminates the propagation of vibrations from the lead suspension to the read/write head.

Embodiments discussed in the Summary of the Invention section are not meant to suggest, describe, or teach all the embodiments discussed herein. Thus, embodiments of the invention may contain additional or different features than those discussed in this section.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a plan view of an HDD according to an embodiment of the invention;

FIG. 2 is a plan view of a head-arm-assembly (HAA) according to an embodiment of the invention;

FIG. 3A is a chart that depicts the modulation of a head due to resonance vibrations;

FIG. 3B is a chart that depicts a frequency plot (FFT) of the distortion depicted in FIG. 3A;

FIG. 4 is a flow chart depicting the high level functional steps of reducing the propagation of vibrations to a head-disk drive (HDD) head according to an embodiment of the invention;

FIG. 5A is a first illustration of a plurality of solder ball joints that each have been applied with dampening material according to an embodiment of the invention;

FIG. 5B is a first illustration of a plurality of solder ball joints that each have been applied with dampening material according to an embodiment of the invention;

FIG. 6A is a graph depicting the distortion of head 110a caused by resonance vibrations when lead suspension 110c vibrates at 4 kHz according to the known state of the art;

FIG. 6B is a graph depicting the elimination of the distortion of a head after the dampening material has been applied to each solder ball joint connecting the lead suspension to the thin-film connectors at the trailing edge of the head according to an embodiment of the invention; and

FIG. 7 is an illustration of a limiter engagement to which a dampening material has been applied according to an embodiment of the invention.

### DETAILED DESCRIPTION OF THE INVENTION

Approaches for reducing the propagation of vibrations to a hard-disk drive (HDD) head are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form in order to avoid unnecessarily obscuring the embodiments of the invention described herein.

### PHYSICAL DESCRIPTION OF ILLUSTRATIVE EMBODIMENTS OF THE INVENTION

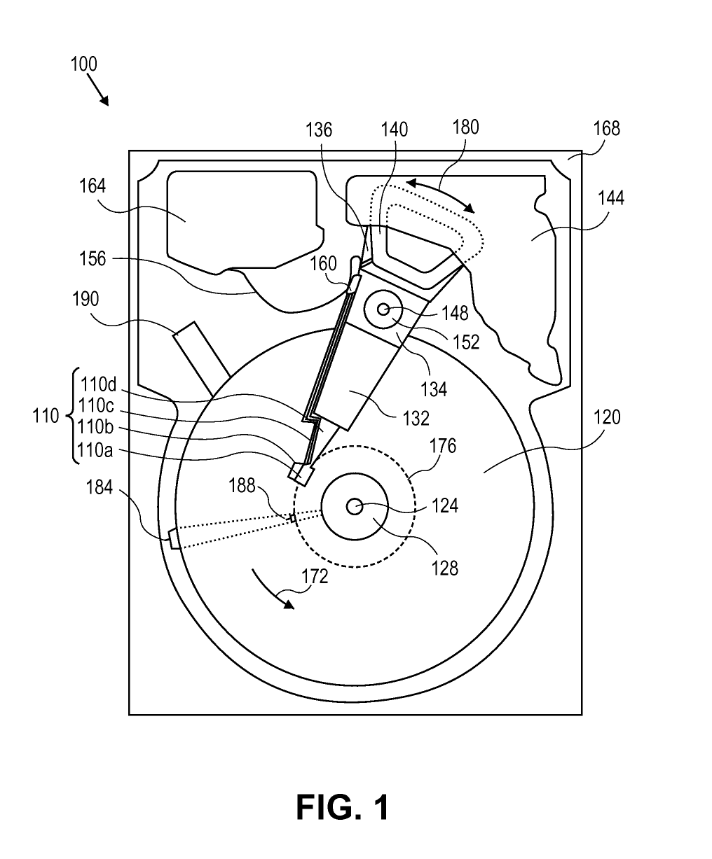

Embodiments of the invention may be implemented using a variety of different storage mediums. For example, embodiments of the invention may be implemented using a magnetic-recording storage medium, such as a hard-disk drive (HDD). With reference to FIG. 1, in accordance with an embodiment of the invention, a plan view of a HDD 100 is shown. FIG. 1 illustrates the functional arrangement of components of the HDD including a slider 110b including a magnetic-recording head 110a. The HDD 100 includes at least one HGA 110 including the head 110a, a lead suspension 110c attached to the head 110a, and a load beam 110d attached to the slider 110b, which includes the head 110a at a distal end of the slider 110b; the slider 110b is attached at the distal end of the load beam 110d to a gimbal portion of the load beam 110d. The HDD 100 also includes at least one magnetic-recording disk 120 rotatably mounted on a spindle 124 and a drive motor (not shown) attached to the spindle 124 for rotating the disk 120. The head 110a includes a write element, a so-called writer, and a read element, a so-called reader, for respectively writing and reading information stored on the disk 120 of the HDD 100. The disk 120 or a plurality (not shown) of disks may be affixed to the spindle 124 with a disk clamp 128. The HDD 100 further includes an arm 132 attached to the HGA 110, a carriage 134, a voice-coil motor (VCM) that includes an armature 136 including a voice coil 140 attached to the carriage 134; and a stator 144 including a voice-coil magnet (not shown); the armature 136 of the VCM is attached to the carriage 134 and is configured to move the arm 132 and the HGA 110 to access portions of the disk 120 being mounted on a pivot-shaft 148 with an interposed pivot-bearing assembly 152.

With further reference to FIG. 1, in accordance with an embodiment of the invention, electrical signals, for example, current to the voice coil 140 of the VCM, write signal to and read signal from the read/write head (typically PMR) 110a, are provided by a flexible cable 156. Interconnection between the flexible cable 156 and the head 110a may be provided by an arm-electronics (AE) module 160, which may have an on-board pre-amplifier for the read signal, as well as other read-channel and write-channel electronic components. The flexible cable 156 is coupled to an electrical-connector block 164, which provides electrical communication through electrical feedthroughs (not shown) provided by an HDD housing 168. The HDD housing 168, also referred to as a casting, depending upon whether the HDD housing is cast, in conjunction with an HDD cover (not shown) provides a sealed, protective enclosure for the information storage components of the HDD 100.

With further reference to FIG. 1, in accordance with an embodiment of the invention, other electronic components (not shown), including a disk controller and servo electronics including a digital-signal processor (DSP), provide electrical signals to the drive motor, the voice coil 140 of the VCM and the head 110a of the HGA 110. The electrical signal provided to the drive motor enables the drive motor to spin providing a torque to the spindle 124 which is in turn transmitted to the disk 120 that is affixed to the spindle 124 by the disk clamp 128; as a result, the disk 120 spins in a direction 172. The spinning disk 120 creates a cushion of air that acts as an air-bearing on which the air-bearing surface (ABS) of the slider 110b rides so that the slider 110b flies above the surface of the disk 120 without making contact with a thin magnetic-recording medium of the disk 120 in which information is recorded. The electrical signal provided to the voice coil 140 of the VCM enables the head 110a of the HGA 110 to access a track 176 on which information is recorded. Thus, the armature 136 of the VCM swings through an arc 180 which enables the HGA 110 attached to the armature 136 by the arm 132 to access various tracks on the disk 120. Information is stored on the disk 120 in a plurality of concentric tracks (not shown) arranged in sectors on the disk 120, for example, sector 184. Correspondingly, each track is composed of a plurality of sectored track portions, for example, sectored track portion 188. Each sectored track portion 188 is composed of recorded data and a header containing a servo-burst-signal pattern, for example, an ABCD-servo-burst-signal pattern, information that identifies the track 176, and error correction code information. In accessing the track 176, the read element of the head 110a of the HGA 110 reads the servo-burst-signal pattern which provides a position-error-signal (PES) to the servo electronics, which controls the electrical signal provided to the voice coil 140 of the VCM, enabling the head 110a to follow the track 176. Upon finding the track 176 and identifying a particular sectored track portion 188, the head 110a either reads data from the track 176 or writes data to the track 176 depending on instructions received by the disk controller from an external agent, for example, a microprocessor of a computer system.

Embodiments of the invention also encompass HDD 100 that includes the HGA 110, the disk 120 rotatably mounted on the spindle 124, the arm 132 attached to the HGA 110 including the slider 110b including the head 110a.

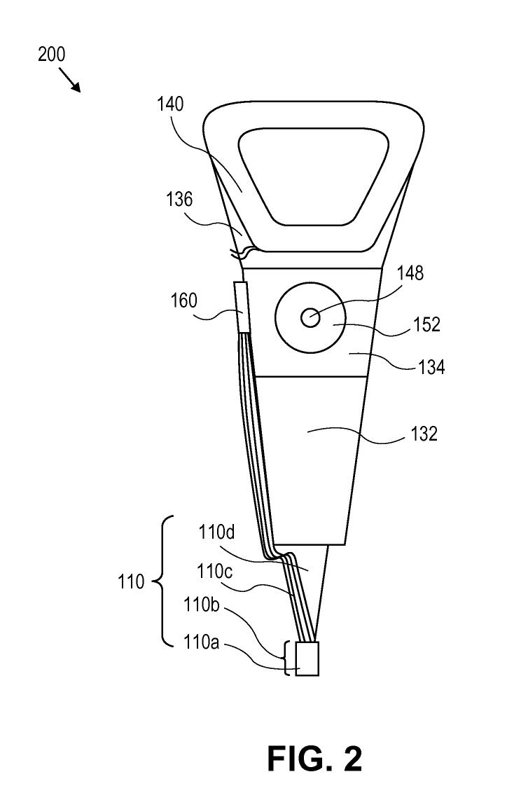

With reference now to FIG. 2, in accordance with an embodiment of the invention, a plan view of a head-arm-assembly (HAA) including the HGA 110 is shown. FIG. 2 illustrates the functional arrangement of the HAA with respect to the HGA 110. The HAA includes the arm 132 and HGA 110 including the slider 110b including the head 110a. The HAA is attached at the arm 132 to the carriage 134. In the case of an HDD having multiple disks, or platters as disks are sometimes referred to in the art, the carriage 134 is called an “E-block,” or comb, because the carriage is arranged to carry a ganged array of arms that gives it the appearance of a comb. As shown in FIG. 2, the armature 136 of the VCM is attached to the carriage 134 and the voice coil 140 is attached to the armature 136. The AE 160 may be attached to the carriage 134 as shown. The carriage 134 is mounted on the pivot-shaft 148 with the interposed pivot-bearing assembly 152.

Note that embodiments of the invention are not limited to storage devices that use a rigid magnetic disk or a magnetic recording medium, as embodiments of the invention may be implemented using a flexible disk substrate or to a recording medium that includes a ferroelectric or phase change, for example.

Having described the physical description of an illustrative embodiment of the invention, discussion will now be presented describing how vibrations may originate as well as propagate to a read/write head.

### How Vibrations May be Propagated to a Read/Write Head and the Problems Resulting Therefrom

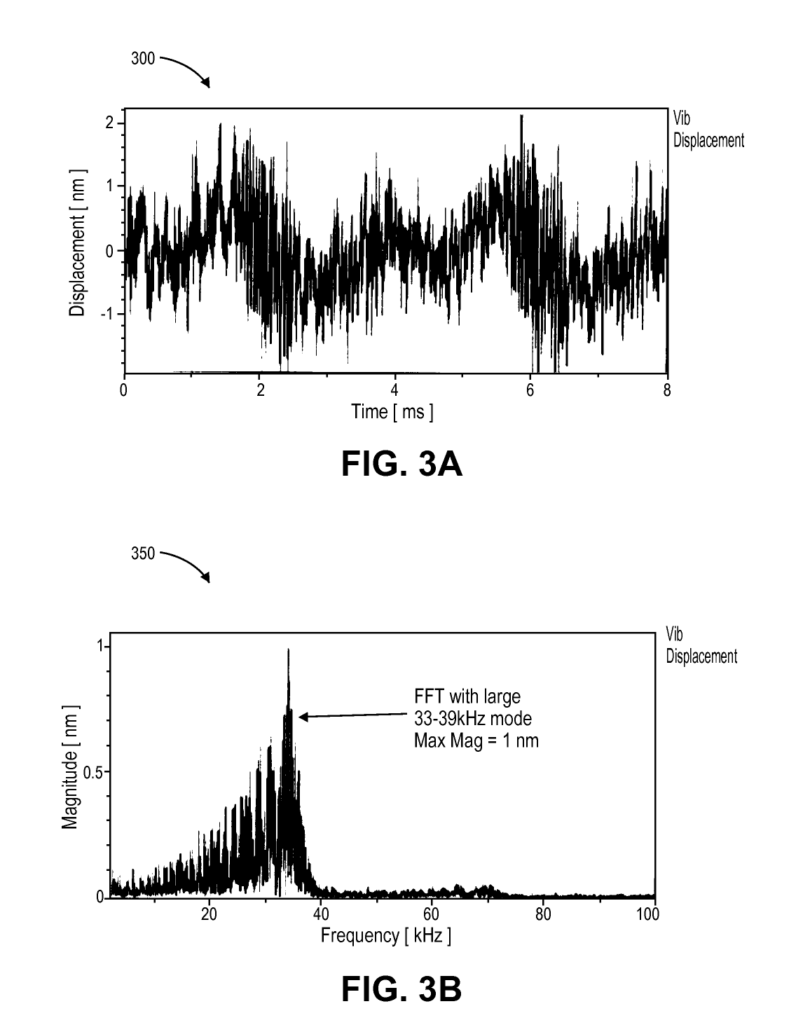

If lead suspension 100c is undergoing vibrations, then these vibrations may be transmitted to head 110a, as head 110a is physically connected to lead suspension 110c. Vibrations may occur in lead suspension 110c for a variety of reasons. For example, lead suspension 110c may experience resonance vibrations. Resonance refers to the tendency of a system to oscillate at a larger amplitude at some frequencies than other frequencies. To illustrate, FIG. 3A is a chart 300 that depicts the modulation of head 110a due to resonance vibrations. The read/write head depicted in chart 300 is undergoing a high frequency distortion. As shown by chart 300, the read/write head is moving +/−2 nanometers, which can negatively affect the operation of HDD 100.

FIG. 3B is a chart 350 that depicts a frequency plot (FFT) of the distortion depicted in chart 300. As shown by chart 350, the critical range of vibration is 33-39 kHz. When lead suspension 110c is vibrating between 33-39 kHz, then lead suspension 110c will undergo a larger distortion than when lead suspension 110c is vibrating at frequencies other than 33-39 kHz. Without the assistance of embodiments of the invention, the distortion that head 110a would undergo as a result of the distortion experienced by lead suspension 110c when lead suspension 110c is vibrating at frequencies between 33-39 kHz may result in an unacceptable amount of error conditions, as head 110a may not be able to read or write properly and/or may physically touch the surface of the disk.

Additionally, if HDD 100 is bumped, lead suspension 110c may oscillate or vibration due to the mechanical shock. The circulating air flow within the enclosure of HDD 100, caused by the rotation of the platters, may also induce vibrations in lead suspension 110c.

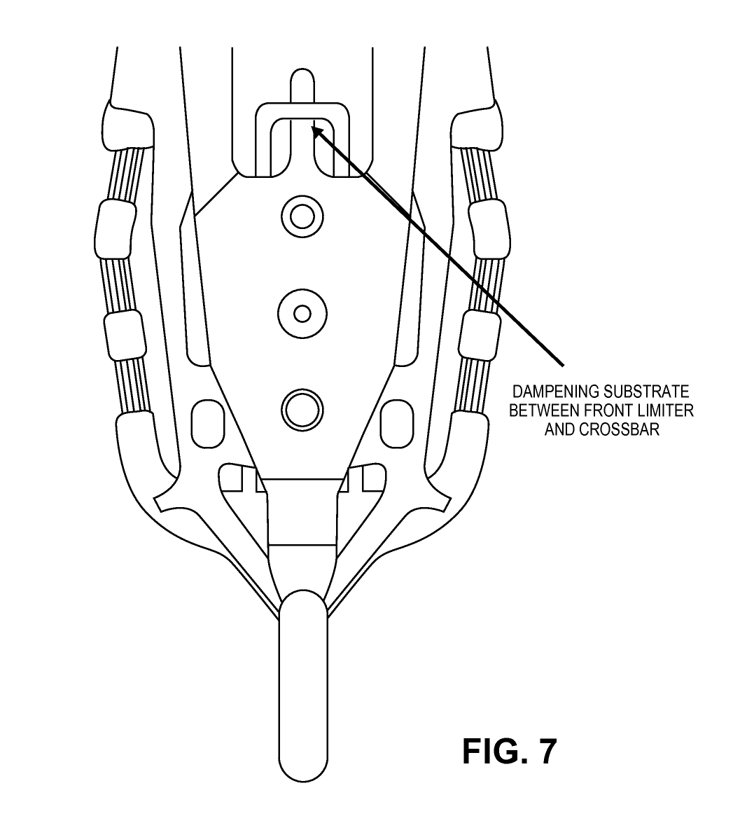

Vibrations may propagate from lead suspension 110c to head 110a at any point of physical contact between lead suspension 110c and head 110a. In an embodiment, a main transmission area for the propagation of vibrations from lead suspension 110c to head 110a is at the solder lead connection of the lead suspension 110c to the thin-film connectors at the trailing edge of head 110a. Another potential transmission area for the propagation of vibrations from lead suspension 110c to head 110a is the limiter engagements. A limiter, shown in FIG. 7, is a mechanical stop to prevent the gimbal assembly from separating away from the suspension assembly.

It is undesirable for vibrations to propagate from lead suspension 110c to head 110a. If head 110a is vibrating, then errors in operations (some of which may be catastrophic and unrecoverable) may occur. If head 110a is experiencing vibrations, then the strength of the magnetic dipole field between head 110a and the surface of the magnetic-recording disk will fluctuate, which may cause problems with reading data from or writing data to the magnetic-recording disk. Also, if head 110a touches the surface of the magnetic-recording medium, then head 110a may scrape across the surface of the magnetic-recording disk, which could grind away the thin magnetic film on the surface magnetic-recording disk, causing scratches, dings and burnish marks and therefore cause data loss and potentially render the HDD inoperable.

Additionally, if head 110a is vibrating, it may be difficult for head 110a to read data from or write data to the appropriate track on the magnetic-recording disk. Head 110a may be particularly susceptible to vibrations during high stress conditions, such as loading head 110a on a ramp, unloading head 110a off a ramp, and track seeking. If head 110a picks up a resonance vibration that causes head 110a to vibrate before an air-bearing is established for head 110a, then head 110a can crash into the magnetic-recording disk, and consequently, destroy the magnetic-recording disk and any information that the magnetic-recording disk has previously recorded.

Head 110a may also vibrate during normal operation of HDD 100, such as when head 110a is seeking a single track or moving from track to track. When head 110a is seeking a single track in normal operation, lateral vibrations may prevent head 110a from being positioned correctly over the desired track, thereby preventing head 110a from being able to read from the desired track or write to the desired track causing track to track misalignment and position error. Also, vibrations during the normal operation of HDD 100 when head 110a is moving from track to track may cause fly height instability.

Consequently, embodiments of the invention provide an advantage over prior approaches by providing mechanisms for reducing or eliminating the propagation of vibrations, such as but not limited to resonance vibrations, from a lead suspension to a head.

### Reducing Vibrations that are Propagated to a HDD Head

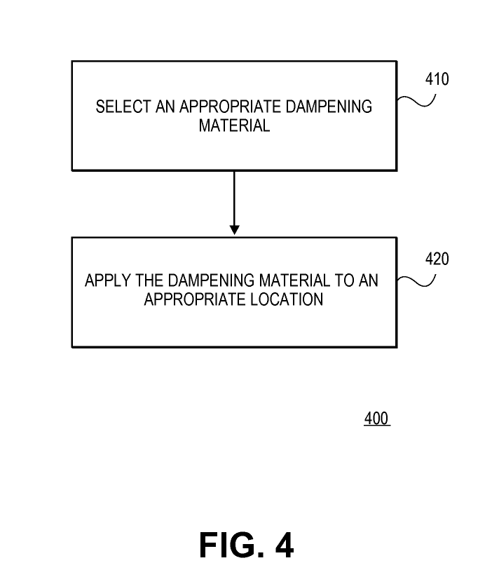

FIG. 4 is a flow chart depicting the high level functional steps of reducing the propagation of vibrations to a head-disk drive (HDD) head according to an embodiment of the invention. Advantageously, by employing embodiments of the invention, the number and magnitude of the vibrations which are propagated from lead suspension 110c to head 110a may be reduced. Thus, by using an embodiment of the invention, the read/write head depicted in chart 350 of FIG. 3B may operate with lead suspension 110c experiencing vibrations in the range of vibration is 33-39 kHz, as embodiments of the invention may dampen, reduce, or eliminate the propagation of vibrations from lead suspension 110c to head 110a to enable head 110a to function properly.

In step 410, an appropriate dampening material is selected. The dampening material selected in step 410 will be applied to an appropriate location to reduce or eliminate the propagation of vibrations from lead suspension 110c to head 110a. The dampening material selected in step 410 may be any material that can absorb vibrations occurring in the lead suspension 110c to prevent their transmission to head 110a. Non-limiting, illustrative examples of a dampening material which may be employed in step 410 include a viscoelastic polymer, a viscous liquid, an epoxy, and glue.

In an embodiment, the particular dampening material selected in step 410 may be selected based on an outgassing property possessed by the dampening material. The outgassing property of a material refers to the type and amount of contaminants that are released or produced by the material. When building a new hard-disk drive (HDD), it is desirable to select a combination of materials which have low outgassing properties to minimize or avoid any contaminants introduced into the interior of HDD 100.

After a particular dampening material is selected for use, in step 420, the dampening material is applied to an appropriate location to prevent the propagation of vibrations to head 110a. In step 420, in an embodiment, the appropriate location (referred to as a transmission area) to which the dampening material is applied in step 420 is a location which is capable of propagating vibrations, such as resonance vibrations, from a source structure to head 110a by virtue of head 110a being physically connected to the source structure at the transmission area.

For example, lead suspension 110c may be a source of vibrations that are propagated to head 110a. Embodiments of the invention may be employed to prevent the propagation of vibrations from a variety of different types of lead suspensions. To illustrate, in an embodiment, lead suspension 110c may be an electrical lead suspension, or more particularly, an integrated lead suspension (ILS), a circuit integrated suspension (CIS), or a flex-on suspension. A flex-on suspension (FOS) is a general term of art that refers to a technology for embedding wires into a polymer on a stiff and flexible substrate for the purpose of getting electronic connections to the magnetic head from the arm-electronics (AE) module 160.

In an embodiment, the location on which the dampening material applied is the solder ball joint of each lead of the lead suspension. The leads may be built into the thin-film element of head 110a and may be coupled to electrical components of head 110a, such as components responsible for reading data, writing data, and a heater element. Note that embodiments of the invention may have different numbers of leads. For example, while 8 leads are common now, 6 leads have been used previously and 10 leads may be used in the future. Thus, in an embodiment, dampening material may be applied to the solder ball joint of any number of leads in steps 420.

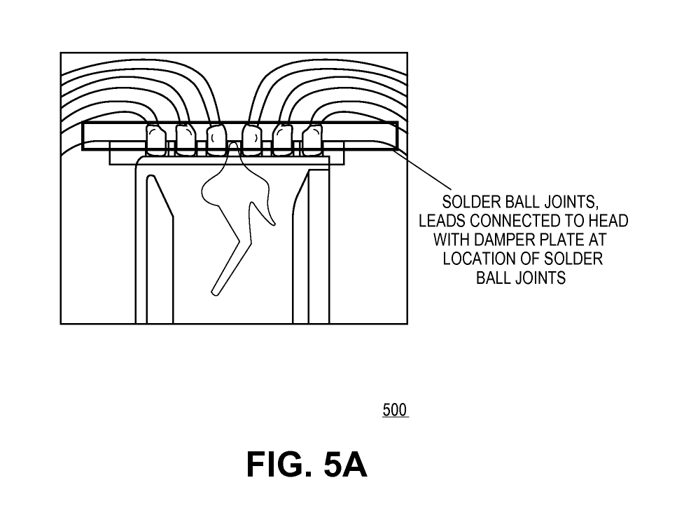

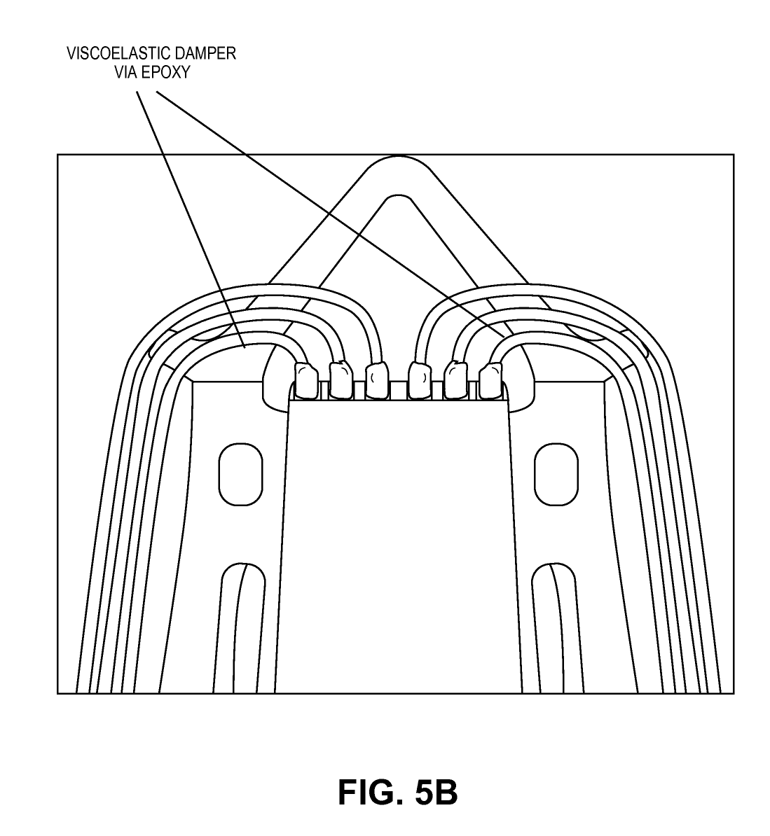

FIG. 5A and FIG. 5B are illustrations 500 and 550 of a plurality of solder ball joints that each have been applied with a dampening material according to an embodiment of the invention. As shown by FIGS. 5A and 5B, in an embodiment, the dampening material may be applied to each solder ball joint connecting the lead suspension to the thin-film connectors at the trailing edge of the head. In such an embodiment, the dampening material would be applied to each solder ball joint.

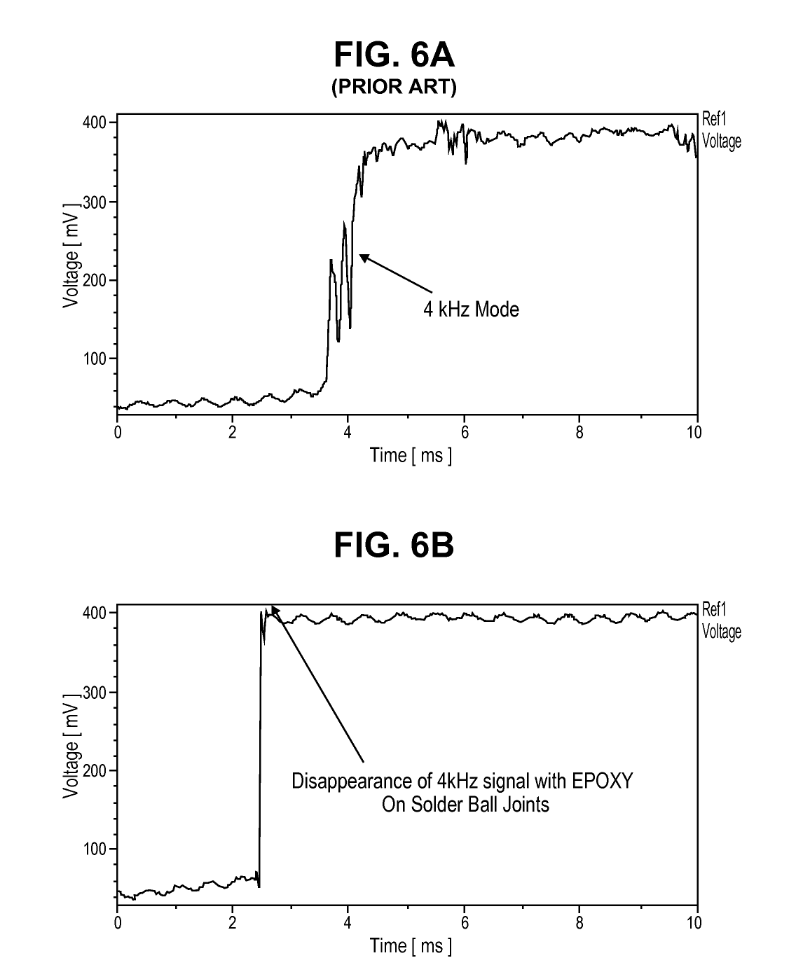

To illustrate how the effect of applying the dampening material to the solder ball joints, consider FIGS. 6A and 6B. FIG. 6A is a graph depicting the distortion of head 110a caused by resonance vibrations when lead suspension 110c vibrates at 4 kHz according to the known state of the art. As shown in FIG. 6A, the head undergoes an undesirable amount of vibrations at 4 kHz. FIG. 6B is a graph depicting the elimination of the distortion of head 110a after the dampening material has been applied to each solder ball joint connecting the lead suspension to the thin-film connectors at the trailing edge of head 110a.

The dampening material may be applied to any location which physically connects lead suspension 110c with head 110a. To illustrate, FIG. 7 is an illustration of a limiter engagement to which a dampening material has been applied according to an embodiment of the invention. In certain embodiments of the invention, dampening material may be applied to multiple locations, such as applying dampening material to both the limiter engagement and each solder ball joint connecting the lead suspension to the thin-film connectors at the trailing edge of the head.

Advantageously, embodiments of the invention are able to eliminate or reduce the propagation of vibrations to head 110a. Desirably, the mass or the head and the flying characteristics of the head have not been modified, as would be the case if the dampening material would be applied to the slider. Also, by applying the dampening material to the location that physically connects lead suspension 110a and head 110c, it is more certain that vibrations will not propagate to head 110a than if the dampening material were applied to the slider.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A hard-disk drive comprising:
a magnetic read/write head;
a magnetic-recording disk rotatably mounted on a spindle;
a drive motor having a motor shaft attached to said spindle for rotating said magnetic-recording disk;
a voice-coil motor configured to move said magnetic read/write head to access portions of said magnetic-recording disk; and
an electrical lead suspension comprising the magnetic read/write head, wherein the magnetic read/write head is connected to the electrical lead suspension by a plurality of leads, wherein a portion of each of the plurality of leads is covered by a dampening material, wherein the dampening material is selected to absorb vibrations occurring in the electrical lead suspension to prevent transmission of the vibrations to the magnetic read/write head.

2. The hard-disk drive of claim 1, wherein the electrical lead suspension is an integrated lead suspension.

3. The hard-disk drive of claim 1, wherein the electrical lead suspension is a circuit integrated suspension.

4. The hard-disk drive of claim 1, wherein the electrical lead suspension is a flex-on suspension.

5. The hard-disk drive of claim 1, wherein the portion of each of the plurality of leads that is covered by the dampening substance is the solder ball joint of each of the plurality of leads.

6. The hard-disk drive of claim 1, wherein the dampening material is a viscoelastic polymer.

7. The hard-disk drive of claim 1, wherein the dampening material is viscous liquid.

8. The hard-disk drive of claim 1, wherein the dampening material is glue.

9. The hard-disk drive of claim 1, wherein the dampening material is selected based on an outgassing property possessed by the dampening material.

10. A hard-disk drive comprising:
a magnetic read/write head;
a magnetic-recording disk rotatably mounted on a spindle;
a drive motor having a motor shaft attached to said spindle for rotating said magnetic-recording disk;
a voice-coil motor configured to move said magnetic read/write head to access portions of said magnetic-recording disk; and
a transmission area that connects an electrical lead suspension with the magnetic read/write head, wherein a portion of the transmission area is covered in a dampening material, wherein the dampening material is selected to absorb vibrations occurring in the electrical lead suspension to prevent their transmission to the magnetic read/write head.

11. The hard-disk drive of claim 10, wherein the transmission area is a limiter engagement.

12. The hard-disk drive of claim 10, wherein the transmission area is a plurality of solder ball joints at the trailer edge of the magnetic read/write head, and wherein the plurality of solder ball joints connect a plurality of thin-film connectors to the electrical lead suspension.

13. The hard-disk drive of claim 10, wherein the dampening material is a viscoelastic polymer.

14. The hard-disk drive of claim 10, wherein the dampening material is viscous liquid.

15. The hard-disk drive of claim 10, wherein the dampening material is glue.

16. The hard-disk drive of claim 10, wherein the dampening material is selected based on an outgassing property possessed by the dampening material.

17. The hard-disk drive of claim 10, wherein the electrical lead suspension is an integrated lead suspension.

18. The hard-disk drive of claim 10, wherein the electrical lead suspension is a circuit integrated suspension.

19. The hard-disk drive of claim 10, wherein the electrical lead suspension is a flex-on suspension.
